(19) United States
(12) Patent Application Publication
(10) Pub. No.: US 2025/0276523 A1
(43) Pub. Date: Sep. 4, 2025

(54) LIQUID EJECTION HEAD SUBSTRATE AND METHOD FOR MANUFACTURING LIQUID EJECTION HEAD SUBSTRATE

(71) Applicant: CANON KABUSHIKI KAISHA, Tokyo (JP)

(72) Inventor: MANABU OTSUKA, Kanagawa (JP)

(21) Appl. No.: 19/068,611

(22) Filed: Mar. 3, 2025

(30) Foreign Application Priority Data
Mar. 4, 2024 (JP) 2024-031791

(51) Int. Cl. B41J 2/14; B41J 2/16

(52) U.S. Cl. CPC B41J 2/14233; B41J 2/161; B41J 2/1623; B41J 2002/14241; B41J 2002/14362; B41J 2002/14491

(57) ABSTRACT

A technique capable of suppressing the occurrence of damage to a covering layer is provided. A liquid ejection head substrate including an energy generation element for imparting energy to liquid includes a first substrate, a second substrate including a bonded surface bonded to a bonded surface of the first substrate via an adhesive and provided with wiring connected to the energy generation element and a covering layer covering the wiring, and a member provided on the bonded surface of at least one of the first substrate and the second substrate and in a position where the member does not overlap the wiring in a direction in which the first substrate and the second substrate are laminated, the member having a height so that a second thickness of the adhesive on the covering layer provided on the wiring is greater than a first thickness of the adhesive on the member.

### BACKGROUND OF THE INVENTION

### Field of the Invention

The present invention relates to a liquid ejection head substrate and a method for manufacturing the liquid ejection head substrate.

### Description of the Related Art

As functional devices, such as microfluidic devices, there are known devices formed of a substrate assembly in which substrates are bonded together with an adhesive. Examples of such devices include a liquid ejection head, such as a print head that ejects ink to perform printing.

Japanese Patent Laid-Open No. 2013-091272 discloses a liquid ejection apparatus including a liquid ejection head with a substrate assembly. In Japanese Patent Laid-Open No. 2013-091272, the substrate assembly includes a pressure generation chamber communicating with a nozzle opening, a piezoelectric layer, and a piezoelectric element having an electrode provided in the piezoelectric layer. In the liquid ejection head, the piezoelectric element is driven to impart pressure to liquid stored in the pressure generation chamber via the piezoelectric layer, thereby ejecting the liquid from the nozzle opening.

However, in the substrate assembly of Japanese Patent Laid-Open No. 2013-091272, in bonding the bonded surface of one substrate on which wiring connected to the piezoelectric element and a covering layer protecting the wiring are formed to the other substrate with an adhesive, the other substrate may contact the covering layer due to a load during bonding, which may damage the covering layer. Even in a case where the other substrate does not contact the covering layer, stress may be applied to the covering layer due to warpage of the substrates during the bonding step, expansion and contraction of a member due to temperature changes during the step of manufacturing the liquid ejection head, and the like, which may damage the covering layer in a place where the adhesive on the covering layer is thin.

### SUMMARY OF THE INVENTION

The present invention is made in view of the above problems and provides a technique capable of suppressing the occurrence of damage to a covering layer.

A liquid ejection head substrate includes: an energy generation element for imparting energy to liquid, the liquid ejection head substrate includes a first substrate, a second substrate comprising a bonded surface bonded to a bonded surface of the first substrate via an adhesive and provided with wiring connected to the energy generation element and a covering layer covering the wiring, and a member provided on the bonded surface of at least one of the first substrate and the second substrate and in a position where the member does not overlap the wiring in a direction in which the first substrate and the second substrate are laminated, wherein the member has a height so that a second thickness of the adhesive on the covering layer provided on the wiring is greater than a first thickness of the adhesive on the member.

The present invention makes it possible to suppress the occurrence of damage to a covering layer.

Further features of the present invention will become apparent from the following description of exemplary embodiments with reference to the attached drawings.

### BRIEF DESCRIPTION OF THE DRAWINGS

FIGS. 1A and 1B are cross-sectional configuration diagrams of a liquid ejection head substrate;

FIGS. 2A and 2B are configuration diagrams of the main portion of a liquid ejection head according to the known art;

FIGS. 3A and 3B are diagrams showing the conditions and results of a simulation conducted by the inventor of the present application;

FIG. 4 is a diagram showing the results of an experiment conducted by the inventor of the present application;

FIGS. 5A to 5C are diagrams for explaining arrangements of spacers on the substrate;

FIG. 6 is a diagram showing the thickness of an adhesive near a spacer during bonding;

FIGS. 7A and 7B are diagrams showing the positional relationship between a recess and the spacer that may cause a crack in the substrate;

FIGS. 8A to 8D are diagrams showing the positional relationship between the recess and the spacer that suppresses the occurrence of a crack in the substrate;

FIGS. 9A to 9C are diagrams showing the positional relationship between the recess and the spacer that suppresses the occurrence of a crack in the substrate;

FIGS. 10A to 10D are diagrams showing the step of manufacturing the liquid ejection head substrate;

FIGS. 11A to 11E are diagrams showing the step of manufacturing the liquid ejection head substrate;

FIGS. 12A to 12C are diagrams showing the step of manufacturing the liquid ejection head substrate;

FIGS. 13A to 13D are diagrams showing the step of manufacturing the liquid ejection head substrate; and

FIGS. 14A and 14B are perspective configuration diagrams of a liquid ejection apparatus and the liquid ejection head.

### DESCRIPTION OF THE EMBODIMENTS

A description will be given below of an example of embodiments for a liquid ejection head substrate and a method for manufacturing the liquid ejection head substrate with reference to the accompanying drawings. It should be noted that the following embodiments do not limit the present invention, and not all of the combinations of features described in the present embodiment are essential to a solution to the problems to be solved by the present invention. Further, the positions, shapes, and the like of constituent elements described in the embodiments are merely examples and are not intended to limit the present invention only thereto.

### Configuration of Liquid Ejection Head Substrate

First, the configuration of a liquid ejection head substrate will be described. It should be noted that in the present embodiment, a case where three substrates are bonded together as a liquid ejection head substrate will be described as an example, but the present invention is not limited to this and can be applied to a case where two or four or more substrates are bonded together. Further, in the present embodiment, the bonding between wafers is described as an example, but the present invention is not limited to this and can be applied to a case where cut pieces (chips) are bonded to a wafer, or a case where the cut pieces are bonded together.

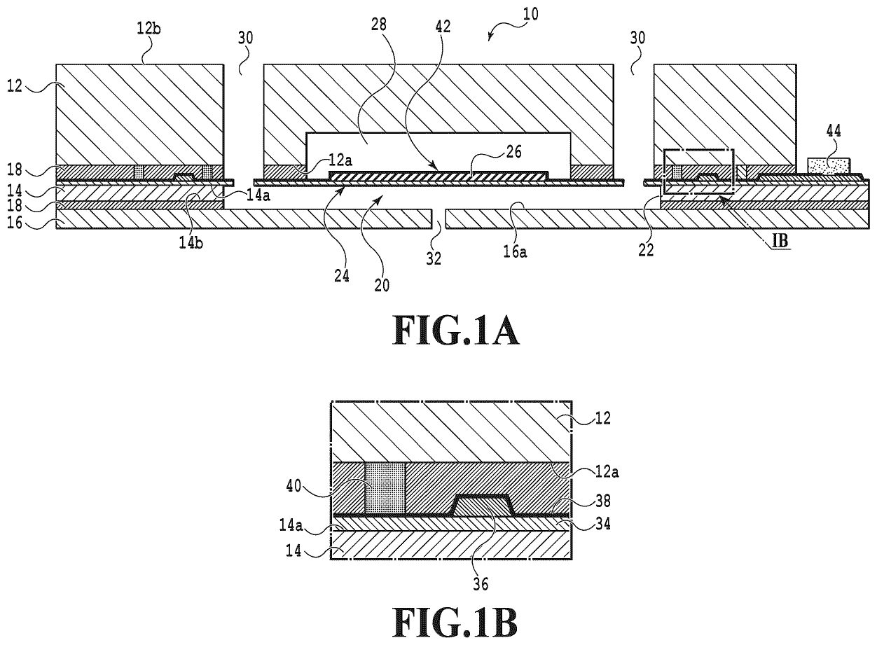

FIG. 1A is a cross-sectional configuration diagram of the liquid ejection head substrate, and FIG. 1B is an enlarged view of the inside of a frame IB in FIG. 1A. A liquid ejection head substrate 10 has a configuration for ejecting liquid. Specifically, the liquid ejection head substrate 10 includes a pressure chamber (hereinafter also referred to as “liquid chamber”) 20 for storing liquid, and a flow path 30 for supplying the pressure chamber 20 with liquid. The liquid ejection head substrate 10 also includes a piezoelectric element 26 as an energy generation element for imparting energy to liquid stored in the pressure chamber 20, and an ejection port 32 through which the liquid stored in the pressure chamber 20 and to which energy is imparted by the piezoelectric element 26 is ejected.

The liquid ejection head substrate 10 includes a first substrate 12, a second substrate 14, and a third substrate 16, and the above-mentioned configuration for ejecting liquid is formed in a bonded substrate in which the three substrates are laminated and bonded together. One surface 12a of the first substrate 12 is bonded to one surface 14a of the second substrate 14 via an adhesive 18. Further, one surface 16a of the third substrate 16 is bonded to the other surface 14b of the second substrate 14 via the adhesive 18. Hereinafter, the “liquid ejection head substrate” will be referred to as “bonded substrate” as appropriate.

The first substrate 12 and the second substrate 14 are, for example, silicon substrates. The second substrate 14 is provided with an opening 22 that forms a pressure chamber 20 in a case where the substrates are bonded together, and a vibration film 24 that serves as a ceiling wall of the pressure chamber 20 and divides a plurality of the pressure chambers 20. The vibration film 24 is provided with a piezoelectric element 26 in a position facing the opening 22 via the vibration film 24. The liquid ejection head substrate 10 is provided with, for example, the plurality of pressure chambers 20, and in the present embodiment, the plurality of pressure chambers 20 are provided in a direction orthogonal to a paper surface in FIG. 1A. Thus, in the second substrate 14, a plurality of the openings 22 are provided in the direction, and the vibration film 24 is provided with the piezoelectric element 26 in each of positions facing the respective openings 22 via the vibration film 24.

The first substrate 12 is provided with a piezoelectric element accommodation portion 28 accommodating the piezoelectric element 26 on the vibration film 24, and a flow path 30 for supplying the pressure chamber 20 with liquid and collecting liquid from the pressure chamber 20. The bonded substrate 10 is provided with an accommodation portion (not shown) accommodating liquid on the other surface 12b side of the first substrate 12. The liquid accommodated in the accommodation portion is then supplied to the pressure chamber 20 through the flow path 30.

The third substrate 16 is, for example, a silicon substrate, and is provided with a plurality of the ejection ports 32. The ejection ports 32 are provided in positions corresponding to the respective openings 22 (pressure chambers 20), and in the present embodiment, the plurality of ejection ports 32 are arranged in the direction orthogonal to the paper surface in FIG. 1A. As a result, in a case where energy is imparted to liquid stored in each pressure chamber 20 by driving the piezoelectric element 26, the liquid is ejected from the ejection ports 32 to the outside of the bonded substrate 10.

In the second substrate 14, an insulation film 34, such as a TEOS film, is formed on the one surface 14a, and wiring 36 connected to the piezoelectric element 26 is formed on the insulation film 34. A covering layer 38 for protecting the wiring 36 is provided on the insulation film 34 and the wiring 36. This covering layer 38 is formed in a predetermined region including the wiring 36, and in the present specification, a portion of the covering layer 38 that covers the wiring 36 is appropriately referred to as a covering portion covering the wiring 36 or the covering layer 38 on the wiring 36. Further, on the covering layer 38, there is provided a spacer (hereinafter, also simply referred to as “member”) 40 for ensuring the thickness of the adhesive 18 between the covering layer 38 on the wiring 36 and the one surface 12a of the first substrate 12.

In the present specification, unless otherwise specified, the term “thickness” refers to a length in a direction in which the substrates are laminated in the bonded substrate 10 (the vertical direction in FIGS. 1A and 1B). In the following description, “a direction in which the substrates are laminated in the bonded substrate 10” is simply referred to as “laminated direction.” In the present embodiment, the one surface 12a of the first substrate 12 is a bonded surface bonded to the second substrate 14, and the one surface 14a side of the second substrate 14 on which the above-mentioned functional film is formed is a bonded surface bonded to the first substrate 12. That is, the bonded surface of the second substrate 14 bonded to the first substrate 12 includes the above-mentioned functional film with the one surface 14a. Incidentally, in the second substrate 14, the other surface 14b is the other bonded surface that faces one bonded surface bonded to the first substrate 12 and is bonded to the third substrate 16.

In the bonded substrate 10, a piezoelectric actuator portion 42 including the piezoelectric element 26 and the like is formed adjacent to the pressure chamber 20. A lower electrode (not shown) connected to the piezoelectric element 26 between the piezoelectric element 26 and the vibration film 24 and an upper electrode (not shown) connected to a piezoelectric element on the piezoelectric element 26 are formed on the vibration film 24 serving as the ceiling wall of the pressure chamber 20. The vibration film 24 is formed by, for example, plasma CVD. A hydrogen barrier film (not shown), the lower electrode, the piezoelectric element 26, and the upper electrode are formed on the vibration film 24 in this order.

The lower electrode and the upper electrode are formed by, for example, the sputtering method, and the piezoelectric element 26 is formed by the sol-gel method. The piezoelectric element 26 may be formed by the sputtering method. For example, a PZT (lead zirconate titanate) film formed by the sol-gel method or the sputtering method can be used for the piezoelectric element 26. The piezoelectric element 26 is made of a sintered body of metal oxide crystal. On the one surface 14a side of the second substrate 14, an interlayer film and the wiring 36 are formed so that the piezoelectric element 26 can be driven, and the piezoelectric actuator portion 42 is configured to be drivable.

The piezoelectric element 26 is provided in a position facing the pressure chamber 20 via the vibration film 24. The vibration film 24 has deformability. The wiring 36 is connected to a pad 44 for electrical connection which serves as a connection terminal for connection with the outside, and is connected to the piezoelectric element 26 via an upper electrode and a lower electrode. In a case where a driving voltage is applied to the piezoelectric element 26 from an external driving IC (not shown) via the pad 44, the wiring 36, the upper electrode, and the lower electrode, the piezoelectric element 26 is deformed by a reverse voltage effect. The deformation of the piezoelectric element 26 deforms the vibration film 24, which results in a change in the volume of the pressure chamber 20, and liquid stored in the pressure chamber 20 is pressurized. The liquid is then ejected from each ejection port 32 communicating with the pressure chamber 20 as droplets by this pressurization, to the outside of the bonded substrate 10.

### Concerns That may Arise in a Case Where no Spacer is Provided

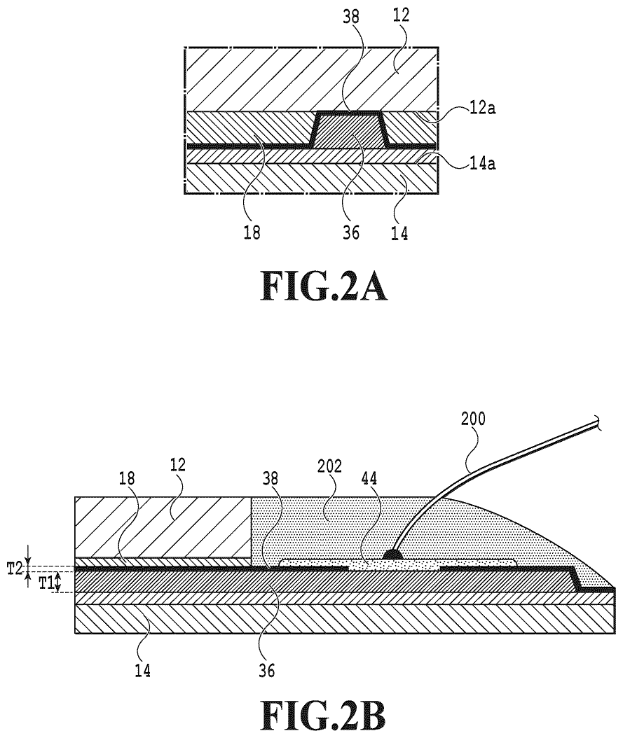

As described above, the bonded substrate 10 is provided with the spacer 40 for ensuring the thickness of the adhesive 18 between the covering layer 38 on the wiring 36 and the one surface 12a of the first substrate 12. Here, concerns that may arise in a case where the spacer 40 is not provided will be described with reference to FIGS. 2A and 2B.

FIGS. 2A and 2B are diagrams for explaining concerns that may arise in a case where the spacer 40 is not provided. FIG. 2A is an enlarged view of the vicinity of the wiring 36 in a portion where the first substrate 12 and the second substrate 14 are adhered to each other. FIG. 2B is an enlarged view of the vicinity of the pad 44 connected to an external terminal 200 and sealed with a sealing agent 202.

In a case where the spacer 40 is not provided between the first substrate 12 and the second substrate 14, a load during bonding may cause contact between the one surface 12a and the covering layer 38 on the wiring 36 in a case where the first substrate 12 and the second substrate 14 are bonded together via the adhesive 18 (see FIG. 2A). In this case, the load during bonding may be directly applied to the covering layer 38 formed on the wiring 36, which may damage the covering layer 38. Even in a place where the covering layer 38 on the wiring 36 and the one surface 12a are close to each other but not in contact with each other, there is a possibility that the covering layer 38 is damaged near an end of the substrate due to stress caused by warpage of the substrate during the manufacturing step or expansion and contraction of the sealing agent that seals the connection portion connected with the external terminal (see FIG. 2B).

Such damage to the covering layer 38 is likely to occur, for example, in a case where the wiring 36 is made of a relatively soft metal such as a metal containing aluminum and where the covering layer 38 is formed of a hard film such as a Si compound (silicon compound) film. That is, the wiring 36 made of a soft metal can be deformed by the above-mentioned stress, while the covering layer 38 formed of a hard film is damaged in the process of deformation due to the above-mentioned stress. Further, in a case where the relationship between the thickness T1 of the wiring 36 made of a soft metal and the thickness T2 of the covering layer 38 formed of a hard film is T1>T2, the covering layer 38 cannot be deformed in response to the deformation of the wiring 36, which increases the possibility of the occurrence of damage.

### Verification by the Inventor of the Present Application

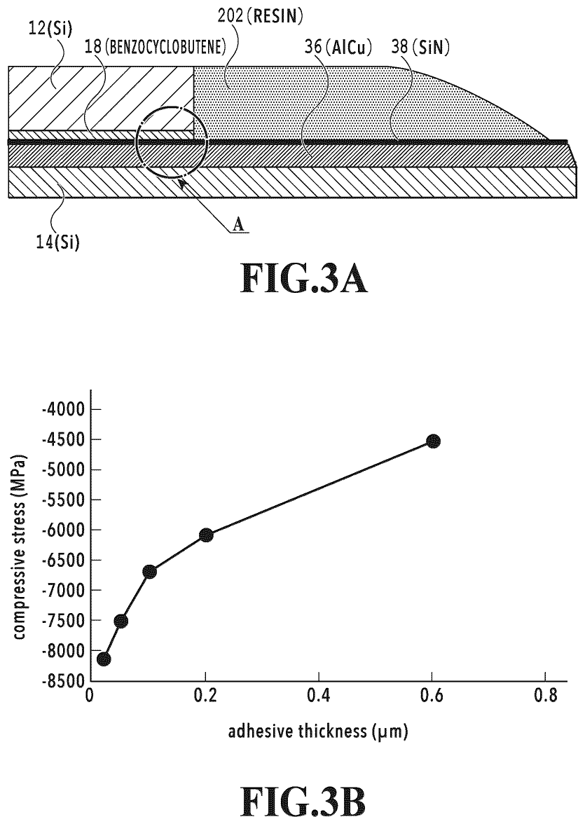

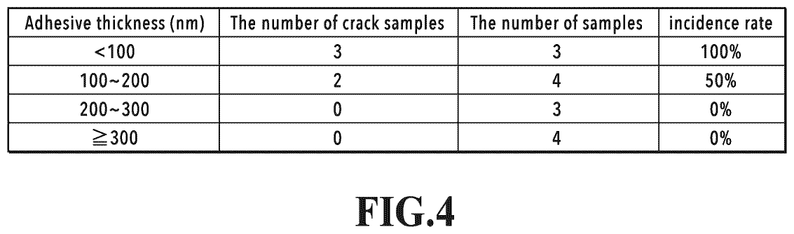

Here, a description will be given of the results of a simulation of compressive stress on the covering layer 38 and an experiment using a temperature cycle test conducted by the inventor of the present application. FIGS. 3A and 3B are diagrams for explaining the simulation conducted by the inventor of the present application. FIG. 3A is a diagram showing the configuration of a substrate on which the simulation was conducted. FIG. 3B is a graph showing the results of the simulation. FIG. 4 is a diagram showing the results of the experiment conducted by the inventor of the present application to verify the crack occurrence rate in the covering layer 38 by conducting the temperature cycle test.

The substrate on which this simulation was conducted imitated the bonded substrate 10 by using Si as the first substrate 12 and the second substrate 14, benzocyclobutene as the adhesive 18, AlCu as the wiring 36, and SiN as the covering layer 38 (see FIG. 3A). Further, a resin was used as the sealing agent 202. The compressive stress applied to the covering layer 38 in a region A (see FIG. 3A) which is a bonded potion between the first substrate 12 and the second substrate 14 and is adjacent to the sealing agent 202 in a case where the temperature was changed from 130° C. to −40° C. was simulated for the substrate imitating the bonded substrate 10. In this simulation, the above-mentioned compressive stress was obtained for a plurality of samples in which the thickness of the adhesive 18 bonding the first substrate 12 and the second substrate 14 together differs.

The results are shown in FIG. 3B. In FIG. 3B, the horizontal axis represents the thickness of the adhesive 18, and the vertical axis represents the compressive stress. As shown in FIG. 3B, the smaller the thickness of the adhesive 18 that bonds the first substrate 12 and the second substrate 14 together is, the larger the compressive stress becomes, and this tendency is more pronounced in a case where the thickness is less than 0.2 μm.

Further, the temperature cycle test was actually conducted using the above-mentioned substrate imitating the bonded substrate 10 to check whether there was a crack in the covering layer 38 according to the thickness of the adhesive 18 between the covering layer 38 on the wiring 36 and the one surface 12a of the first substrate 12. In this temperature cycle test, the high temperature was 130° C., and the low temperature was −40° C. The results of this temperature cycle test are shown in FIG. 4. In a case where the thickness of the adhesive 18 was less than 100 nm, cracks occurred in the covering layer 38 in all three samples, and the crack occurrence rate was 100%. In a case where the thickness of the adhesive 18 was 100 nm or more and less than 200 nm, cracks occurred in the covering layer 38 in two samples out of four samples, and the crack occurrence rate was 50%. Further, in a case where the thickness of the adhesive 18 was 200 nm or more and less than 300 nm, no cracks occurred in the covering layer 38 in all three samples, and the crack occurrence rate was 0%. Furthermore, in a case where the thickness of the adhesive 18 was 300 nm or more, no cracks occurred in the covering layer 38 in all four samples, and the crack occurrence rate was 0%.

In this experiment, cracks were observed in a case of a thickness of less than 200 nm (0.2 μm), where an increase in compressive stress becomes significant in the above simulation, and no cracks were observed in a case of a thickness of 200 nm or more, where the increase in compressive stress is relatively gradual in the above simulation. Thus, the results of the present experiment correspond to the results of the above simulation.

### Spacer

The inventor of the present application finds from the results of the above-mentioned simulation and experiment that the occurrence of damage to the covering layer 38 can be suppressed depending on the thickness of the adhesive 18 between the covering layer 38 on the wiring 36 and the first substrate 12. Thus, in the present embodiment, the spacer 40 is provided between the first substrate 12 and the second substrate, and in a case of bonding, the spacer 40 causes the adhesive 18 between the covering layer 38 on the wiring 36 and the first substrate 12 to have a thickness large enough to suppress the occurrence of damage to the covering layer 38. In the present embodiment, the thickness large enough to suppress the occurrence of damage to the covering layer 38 on the wiring 36 is based on a load in a case of bonding and stress due to warpage of the substrate during the manufacturing step and expansion and contraction of the sealing agent.

### Overview of Spacer

A plurality of the spacers 40 are formed on at least one of the one surface 12a of the first substrate 12 and the one surface 14a of the second substrate 14. That is, all of the spacers 40 may be provided on the one surface 12a side, the one surface 14a side, or both of the one surface 12a side and the one surface 14a side. It should be noted that a plurality of the spacers 40 do not necessarily have to be provided, and only one spacer 40 may be provided depending on the size of the substrate, the pattern of the wiring 36, and the like.

The spacer 40 is provided in a position where the spacer 40 does not overlap the wiring 36 or the covering portion of the covering layer 38 that covers the wiring 36 in a plane orthogonal to the laminated direction (i.e., a plane parallel to the first substrate 12 and the second substrate 14) in a case of bonding the first substrate 12 and the second substrate 14 together. In other words, the spacer 40 is provided in a position where the spacer 40 does not overlap the wiring 36 or the covering portion in a case where the bonded substrate 10 is viewed in the laminated direction (i.e., the upper or lower side in FIGS. 1A and 1B). In a case where the spacer 40 is provided in a position where the spacer 40 overlaps the wiring 36 and the covering portion, there is a possibility that a load in a case of bonding the first substrate 12 and the second substrate 14 together concentrates on the wiring 36 and the covering portion through the spacer 40 and that the covering portion of the covering layer 38 is damaged. Further, the length (hereinafter also referred to as “height”) of the spacer 40 in the laminated direction is greater than the sum of the thicknesses of the wiring 36 and the covering portion.

Appropriately adjusting the arranged position and the length in the laminated direction of the spacer 40 makes it possible to control the thickness of the adhesive 18 between the covering layer 38 on the wiring 36 and the bonded surface of the substrate facing the covering layer 38. As a result, for example, even in a case where the covering layer 38 formed of a hard film such as a Si compound film is formed on the wiring 36 made of a relatively soft metal including aluminum, damage to the covering layer 38 can be suppressed. Further, even in a case where the relationship between the thickness T1 of the wiring 36 and the thickness T2 of the covering layer 38 on the wiring 36 is T1>T2, damage to the covering layer 38 can be suppressed.

There is known a technique in which an adhesive containing a filler of a predetermined particle size is used as a spacer to control the thickness of an adhesive layer bonding the first substrate 12 and the second substrate 14 together without providing the first substrate 12 or the second substrate 14 with the spacer 40. However, such a technique has a possibility that in a case of bonding the first substrate 12 and the second substrate 14 together, the filler overlaps the covering portion of the covering layer 38 that covers the wiring 36 and damages the covering layer 38 (covering portion).

In a case where the present invention is applied to a multilayer wiring substrate, spacers are arranged only in positions corresponding to wiring projected from a provided substrate surface and a covering layer on the wiring. Incidentally, in a case where non-convex multilayer wiring has sufficient strength, spacers may be arranged on the multilayer wiring.

### Arrangement of Spacers

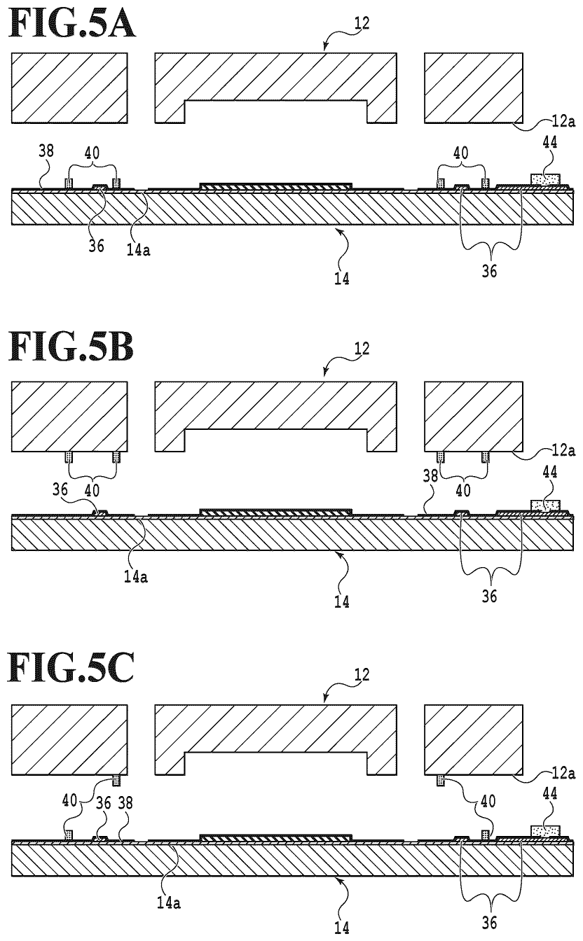

Next, arrangements of the spacers 40 in the first substrate 12 and the second substrate 14 will be described with reference to FIGS. 5A to 5C. FIGS. 5A to 5C are diagrams for explaining arrangements of the spacers 40 in the substrates, FIG. 5A is a diagram showing the spacers 40 formed in the second substrate 14, FIG. 5B is a diagram showing the spacers 40 formed in the first substrate 12, and FIG. 5C is a diagram showing the spacers 40 formed in the first substrate 12 and the second substrate 14.

As described above, the spacer 40 may be provided in the first substrate 12 or the second substrate 14 as long as the spacer 40 does not contact the wiring 36 or the covering portion of the covering layer 38 that covers the wiring 36 (see FIGS. 5A and 5B). Alternatively, the spacer 40 may be provided on both the first substrate 12 and the second substrate 14 (see FIG. 5C).

The spacer 40 can be formed at the same time as at least one functional film provided in a substrate. In other words, the spacer 40 can be formed of the same material as the material for at least one functional film provided in the substrate and in the same process. Accordingly, in a case where a functional film is formed on the one surface 14a side of the second substrate 14 (see FIG. 5A), the spacer 40 can be formed of the same material as that for the functional film during the step of forming the functional film. Further, in a case where a functional film is formed on the one surface 12a side of the first substrate 12, the spacer 40 can be formed of the same material as that for the functional film during the step of forming the functional film. The material for the spacer 40 may be different from that for the functional film. Even in a case where the spacer 40 is formed of the same material as that for the functional film, the spacer 40 may be formed in a step different from the step of forming the functional film made of the same material.

Further, in a case where the adhesion of the spacer 40 is low on the one surface 14a side of the second substrate 14, there is a possibility that the spacer 40 drops in the step of forming the spacer 40. In such a case, in a case where the adhesion of the spacer 40 on the one surface 12a side of the first substrate 12 is relatively high, the spacer 40 may be formed on the one surface 12a side of the first substrate 12 (see FIG. 5B). Accordingly, in this case, the spacer 40 is formed directly on the one surface 14a on which no functional film is formed. That is, the spacer 40 may be formed directly on the bonded surface of a substrate.

### Height of Spacer

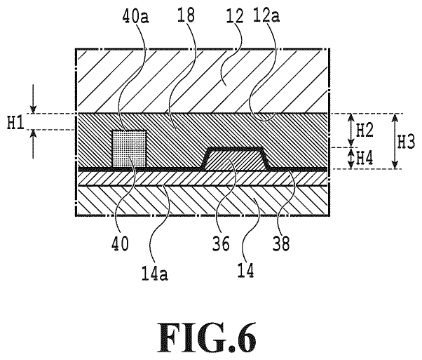

Next, the height of the spacer 40 will be described. FIG. 6 is a diagram showing the thickness of the adhesive 18 near the spacer 40 during bonding. It should be noted that this description uses as an example a case where the spacer 40 is formed on the one surface 14a side of the second substrate 14.

In a case of bonding the first substrate 12 and the second substrate 14 together, the spacer 40 contacts the one surface 12a, so that the thickness H3 (see FIG. 6) of the adhesive 18 between the first substrate 12 and the second substrate 14 can be adjusted to the height of the spacer 40. More specifically, the thickness H3 is the thickness of the adhesive 18 between the one surface 12a of the first substrate 12 and a functional film (the covering layer 38 not located on the wiring 36 in FIG. 6) provided on the one surface 14a of the second substrate 14. Further, adjusting the height of the spacer 40 makes it possible to adjust the thickness H2 (see FIG. 6) of the adhesive 18 between the covering layer 38 on the wiring 36 and the one surface 12a.

In a case of bonding the first substrate 12 and the second substrate 14 together, it is not necessary for all the spacers 40 to contact the one surface 12a. That is, there may be spacers 40 with the adhesive 18 remaining between the spacers 40 and the one surface 12a according to variations in the heights of the spacers 40, variations in the thicknesses of the first substrate 12 and the second substrate 14, and the like (see FIG. 6). In order to suppress variations in the thickness H3, it is preferable that the thickness H1 (see FIG. 6) of the adhesive 18 between the spacer 40 and the one surface 12a be 0 μm or more and 0.3 μm or less. In the present embodiment, since the thickness H2 (see FIG. 6) is adjusted by the spacer 40, at least one of the plurality of spacers 40 contacts the one surface 12a, that is, the thickness H1 is 0 μm.

Further, based on the findings made by the inventor of the present application, in order to suppress damage to the covering layer 38 on the wiring 36, it is necessary to set the thickness H2 of the adhesive 18 between the covering layer 38 on the wiring 36 and an opposing substrate to be greater than the thickness H1 of the adhesive 18 between the spacer 40 and the opposing substrate. The thickness H2 corresponds to the thickness of the adhesive layer (Adhesive thickness) in the table in FIG. 4.

Thus, in view of the results of the above simulation and experiment, in order to suppress damage to the covering layer 38 on the wiring 36, it is necessary that H2>H1 and that the thickness H2 be increased to relieve stress generated during the manufacturing step. Based on the results of the above simulation and experiment, the thickness H2 is preferably set to H2≥0.6 μm at which the stress is reduced by 25% based on the stress in a case where the thickness H2 at which damage occurs is set to H2≈0.2 μm (see FIG. 3B). Although not shown in FIG. 3B, it is more preferable that H2≥1.0 μm at which the stress is reduced by approximately 50% in the above simulation conducted by the inventor of the present application.

In a case where the thickness H3 is increased, the flow path 30 and the piezoelectric element accommodation portion 28 cannot be cohesively broken in a case of the adhesive 18 being transferred, and the adhesive 18 remains in the openings of the flow path 30 and the piezoelectric element accommodation portion 28 or overflows. This may affect the functions of the flow path 30 and the piezoelectric element accommodation portion 28. Thus, the thickness H3 adjustable by the spacer 40 is preferably 3.5 μm or less. Accordingly, an upper limit value for the height of the spacer 40 is, for example, 3.5 μm or a predetermined value smaller than 3.5 μm. Further, a lower limit value for the height of the spacer 40 is a value that satisfies the above conditions for the H2 (i.e., it is preferable that H2≥0.6 μm, and it is more preferable that H2≥1.0) in accordance with the sum H4 of the thickness of the wiring 36 and the thickness of the covering layer 38 on the wiring 36. Thus, in the present embodiment, the spacer 40 is configured so that the thickness of the adhesive 18 between the covering layer 38 on the wiring and the opposing substrate is a thickness that makes it difficult to cause damage to the covering layer 38 based on a load in a case of bonding and stress due to warpage of the substrate caused by temperature changes during a process or due to expansion and contraction of the sealing agent.

### Shape of Substrate and Spacer

In a case where substrates are bonded together using an adhesive, a recess, such as an adhesive escape groove, may be formed on the bonded surface of a substrate to accommodate an excess adhesive. However, in a case where such a recess is formed on the bonded surface of a substrate facing the spacer 40 (the one surface 12a in FIG. 6), a crack may occur in the substrate with the recess formed.

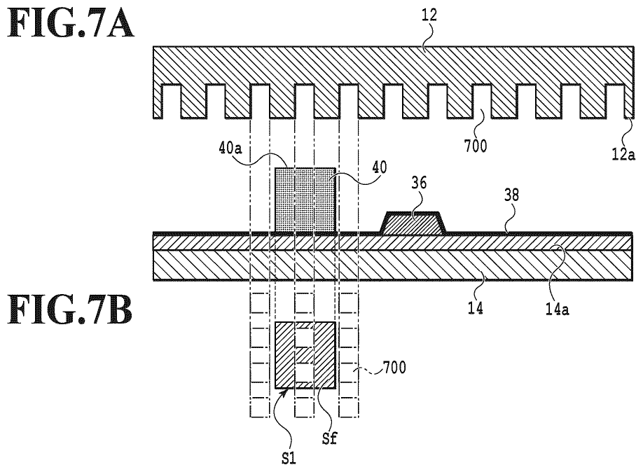

Here, a description will be given of the occurrence of cracks due to the spacer 40 for a substrate in which a recess is formed with reference to FIGS. 7A and 7B. FIGS. 7A and 7B are diagrams showing the positional relationship between a recess 700 for accommodating the excess adhesive 18 and the spacer 40. FIG. 7A is a cross-sectional view of the vicinity of the spacer 40 in the first substrate 12 in which the recess 700 is formed and the second substrate 14 on which the spacer 40 is provided. FIG. 7B is a diagram showing the positions of a region S1 that can abut an upper surface 40a of the spacer 40 on the one surface 12a and the recess 700 near the region S1.

In a case where the first substrate 12 in which the recess 700 is formed on the one surface 12a is bonded to the second substrate 14 in which the spacer 40 is provided on the one surface 14a side, a load generated between the spacer 40 and the one surface 12a during bonding is applied to portions other than the recess 700 in the region S1. That is, in a case where the recess 700 is not formed, a load is applied to the entire surface of the region S1. On the other hand, in a case where the recess 700 is formed, a load is applied to a region Sf (see a hatched portion in FIG. 7B) in the region S1 where the recess 700 is not formed, that is, an area smaller than the region S1. Thus, cracks may occur in the first substrate 12 in which the recess 700 is formed.

That is, in a case where the ratio of the total area of the recesses 700 in the region S1 to the area of the region S1 increases, the area of the region Sf in the region S1 is reduced, which increases a load on the region Sf and causes a crack in the first substrate 12. For example, in a case where the total area of the recesses 700 in the region S1 is 50% of the area of the region S1, a load which is twice as much as the load in a case where no recess 700 is formed in the region S1 is applied to the region Sf where no recess 700 is formed in the region S1.

Thus, in the present embodiment, the recesses 700 are formed so that the total area of the recesses 700 in the region S1 is 0% or more and less than 20% of the area of the region S1 in consideration of variations in the area of the region S1 on the one surface 12a that may contact the spacer 40. It should be noted that whether a crack occurs in the first substrate 12 depends on a load generated during bonding, the material for the substrate, variations in the height of the spacer 40, the material for the spacer 40, and the like. Thus, the value “20%” mentioned above is determined, for example, experimentally depending on the material for substrates to be bonded together, the shape of and material for the spacer 40, and the like.

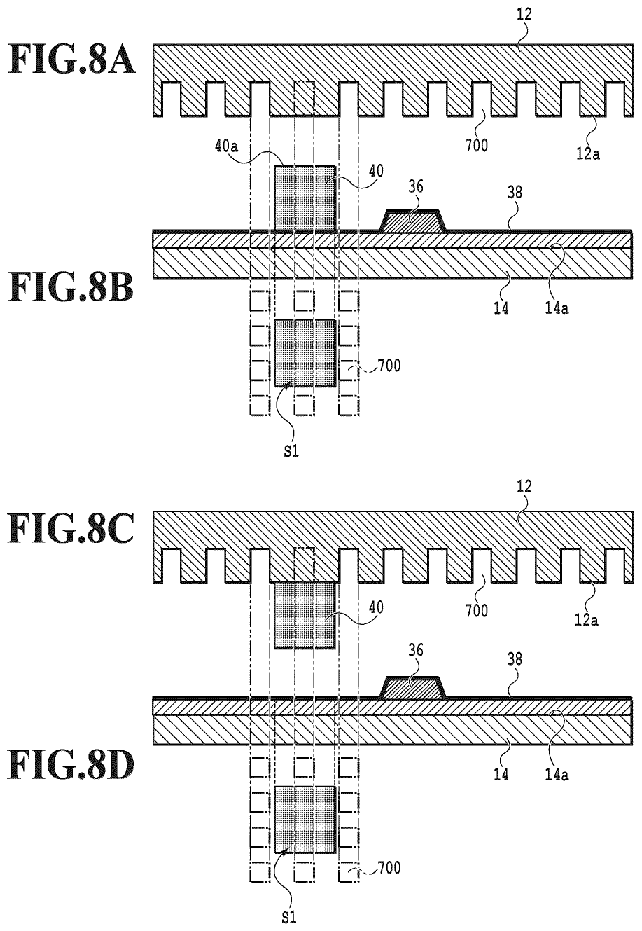

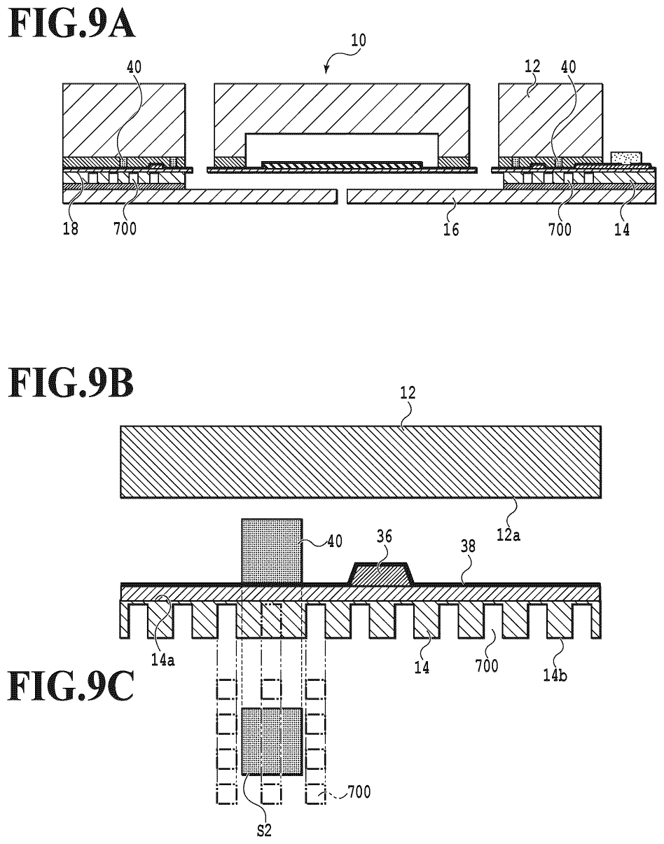

Hereinafter, a description will be given of a technique for suppressing the occurrence of cracks due to the spacer 40 on the substrate in which the recess 700 is formed with reference to FIGS. 8A to 9C. FIGS. 8A to 8D are diagrams showing an example of the formation of the recess 700 for suppressing the occurrence of cracks. FIG. 8A shows an example of the formation of the recess 700 near the spacer 40, and FIG. 8B is a diagram showing the positions of the region S1 and the recess 700 near the region S1 in FIG. 8A. FIG. 8C shows another example of the formation of the recess 700 near the spacer 40, and FIG. 8D is a diagram showing the positions of the region S1 and the recess 700 near the region S1 in FIG. 8C. FIG. 9A is a diagram showing an example of the formation of the recess 700 in a case where the recess 700 is provided in the second substrate 14 on which the spacer 40 is provided. FIG. 9B is an enlarged view of the vicinity of the spacer on the second substrate 14 in FIG. 9A. FIG. 9C is a diagram showing the positions of a region S2 overlapping the spacer 40 and the recess 700 near the region S2 on the other surface 14b in which the recess 700 is formed.

In order to suppress the occurrence of cracks in the first substrate 12 in which the recess 700 is formed, for example, the recess 700 is not formed in the region S1 (that is, the area of the recess 700 in the region S1 is 0% of the area of the region S1) (see FIG. 8A). In a case where there is a concern about the influence of misalignment between the first substrate 12 and the second substrate 14 during bonding, the spacer 40 may be formed in the region S1 (see FIG. 8C). This allows the spacer 40 to be located in the region S1 with high accuracy, so that the influence of the misalignment can be suppressed. Incidentally, in the description with reference to FIGS. 8A to 8D, a case where the area of the recess 700 in the region S1 is 0% of the area of the region S1 has been described, but it is only required that the area of the recess 700 in the region S1 be 0% or more and less than 20% of the area of the region S1.

Further, in the step of manufacturing the bonded substrate 10 or a liquid ejection head provided with the bonded substrate 10, stress is generated around the spacer 40 due to the difference in thermal expansion and elastic modulus between the spacer 40 and the adhesive 18. Accordingly, in a case where the recess 700 for accommodating the excess adhesive 18 for bonding to the third substrate 16 is formed on the other surface 14b of the second substrate 14 provided with the spacer 40 on the one surface 14a side, the second substrate 14 may be damaged by the above-mentioned stress. Thus, in a case where the recess 700 is provided on the other surface 14b of the second substrate 14 provided with the spacer 40, it is preferable that the recess 700 be arranged in a position where the recess 700 does not overlap the spacer 40 in a plane orthogonal to the laminated direction (see FIG. 9A).

That is, the recess 700 provided on the other surface 14b is formed in a position where the recess 700 does not overlap the spacer 40 provided on the one surface 14a side in a plane parallel to the second substrate 14. Alternatively, the recess 700 is not formed selectively so that the spacer 40 does not overlap the recess 700 in a plane parallel to the second substrate 14 (see FIGS. 9B and 9C). Incidentally, in the description with reference to FIGS. 9A to 9C, a case where the area of the recess 700 in the region S1 is 0% of the area of the region S2 has been described, but it is only required that the area of the recess 700 in the region S2 be 0% or more and less than 20% of the area of the region S2.

### Material for Spacer

The material for the spacer 40 is not specifically limited, but it is preferable to use a material that is not easily deformed by a load during bonding, and an inorganic material is suitable. The spacer 40 may be made of a single material or may be made of a plurality of materials. Further, it is preferable that all or a portion of the spacers 40 be formed on the second substrate 14. In a case of forming the spacer 40 on the second substrate 14, it is preferable that the spacer 40 be formed in a case of formation of at least one type of functional film formed on the one surface 14a of the second substrate 14 such as the upper electrode, the piezoelectric element 26, the lower electrode, the wiring 36, and the pad 44.

For example, in a case where the spacer 40 is formed at the same time as the pad 44, since the pad 44 is often formed by Au plating, the spacer 40 is formed of relatively soft Au. In this case, in a case where a load is applied to the spacer 40 during bonding, an influence on the substrate is reduced. Incidentally, in a case where the spacer 40 is formed by Au plating, it is preferable to form a seed layer on an insulation film on the one surface 14a of the second substrate 14. In this case, an insulation layer on the one surface 14a may be the same film as the covering layer 38. Although details will be described later, for example, in a case where the covering layer 38 is SiN, TiW and Au are laminated as a seed layer on SiN by the sputtering method to form a film. Positions where the pad 44 and the spacer 40 are to be formed are then formed by resist patterning, and the Au plating is selectively grown in the positions. After that, the pad 44 and the spacer 40 are formed simultaneously by removing the excess TiW and Au.

In a case where the steps of growing the Au plating on the spacer 40 and the pad 44 are performed simultaneously as described above, the spacer 40 and the pad 44 having the same thickness are formed. However, the spacer 40 and the pad 44 having different thicknesses may be formed. For example, in a case of electrical connection, in a case where the pad 44 is thick, it is possible to easily perform the step of electrical connection and to prevent a short circuit with the substrate. In a case where the pad 44 and the spacer 40 having different thicknesses are formed, after TiW and Au are formed into a film as a seed layer, resist patterning and the step of growing the Au plating are performed on the pad 44 and the spacer 40. In this way, the pad 44 and the spacer 40 each having a desired thickness can be formed.

### Method for Manufacturing Bonded Substrate 10

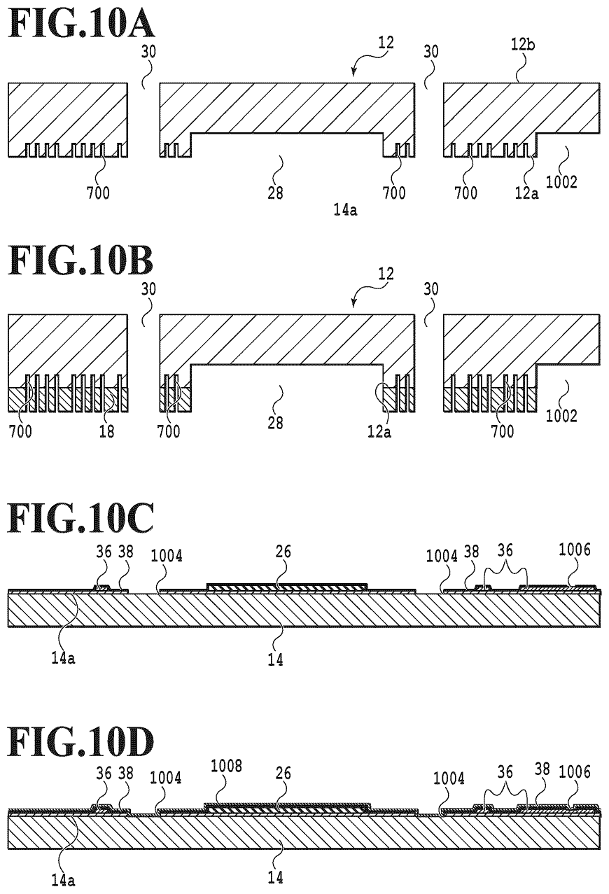

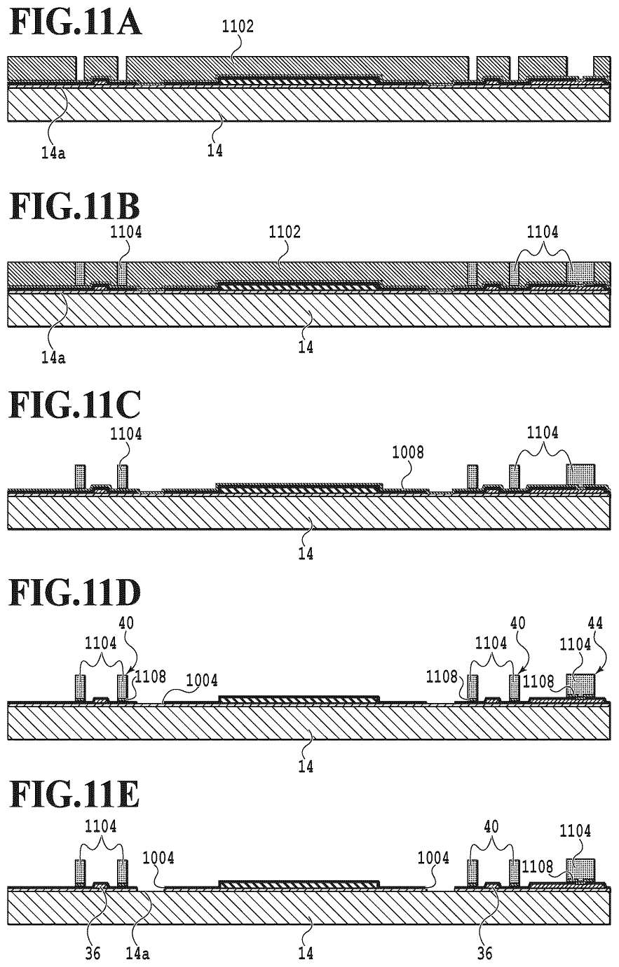

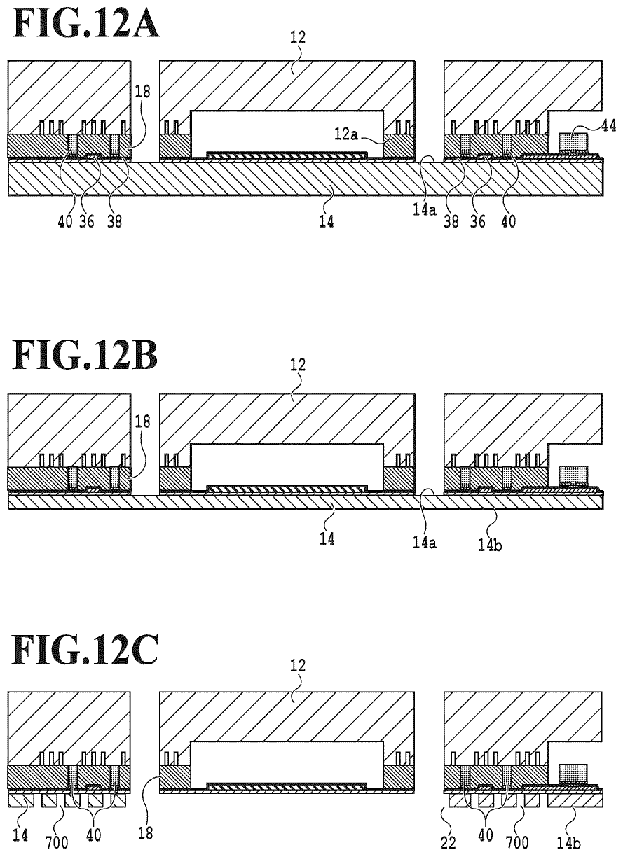

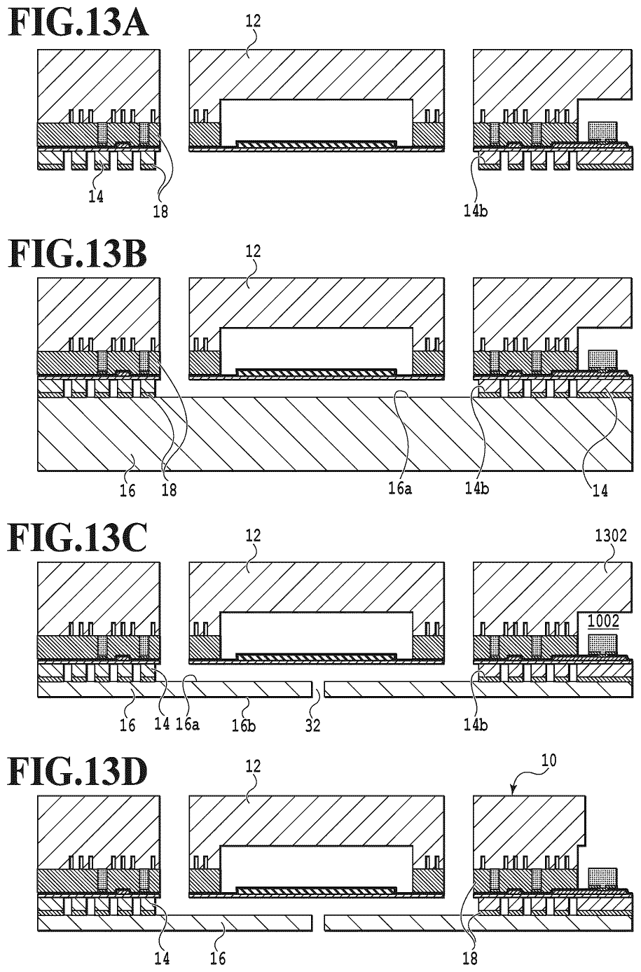

Next, a description will be given of an example of a method for manufacturing the bonded substrate 10 according to the present embodiment with reference to FIGS. 10A to 13D. FIGS. 10A to 13D are diagrams showing the step of manufacturing the bonded substrate 10. FIGS. 10A and 10B are diagrams showing the step of working the first substrate 12, and FIGS. 10C and 10D are diagrams showing the step of forming the functional film of the second substrate 14. FIGS. 11A to 11E are diagrams showing the step of forming the functional film of the second substrate 14. FIG. 12A is a diagram showing the step of bonding the second substrate 14, and FIGS. 12B and 12C are diagrams showing the step of working the second substrate 14. FIGS. 13A and 13B are diagrams showing the step of bonding the third substrate 16, FIG. 13C is a diagram showing the step of working the third substrate 16, and FIG. 13D is a diagram showing the resulting bonded substrate 10. In the following description, a manufacturing method in which the spacer 40 is formed at the same time as the pad 44 will be described. Further, the method for working a substrate and the method for forming a functional film described below are not limited to the following methods, and various known techniques can be used.

### Step of Working First Substrate 12

First, the first substrate 12 is prepared, and the flow path 30, the piezoelectric element accommodation portion 28, a pad storage portion 1002 for storing the pad 44, and the recess 700 are formed in the first substrate 12. In a case where the first substrate 12 is, for example, a silicon substrate, a semiconductor manufacturing process can be used to form each of these components. Specifically, after forming a desired etching mask on the surface of the first substrate 12, the first substrate 12 can be worked by performing Si dry etching. The etching mask can be formed by, for example, exposing, developing, and patterning a novolac-based photoresist. For Si dry etching, it is possible to use an etching technique called the so-called Bosch process using, for example, SF₆ gas in an etching step and C₄F₈ gas in a coating step. Further, it is also possible to thin the substrate as necessary.

Specifically, the above working method is used to form the flow path 30 penetrating from the one surface 12a to the other surface 12b of the first substrate 12. Further, the piezoelectric element accommodation portion 28, the pad storage portion 1002, and the recess 700 are formed on the one surface 12a (see FIG. 10A). These components may be formed simultaneously in the same step, or may be formed individually in different steps. It should be noted that the recess 700 for storing the excess adhesive 18 is formed continuously around the flow path 30 and the piezoelectric element accommodation portion 28 on the one surface 12a, but is not formed in a location corresponding to the spacer 40 provided on the second substrate 14 during bonding with the second substrate 14.

Thereafter, the adhesive 18 is applied by transfer onto the one surface 12a of the first substrate 12 (see FIG. 10B). In this case, the adhesive 18 is not transferred onto the flow path 30, the piezoelectric element accommodation portion 28, the pad storage portion 1002, and the recess 700. In the present embodiment, the adhesive 18 is made of a benzocyclobutene resin, which is a thermosetting resin whose viscosity varies according to the temperature, so that the height of the spacer 40 is easily controlled during bonding. Further, the adhesive 18 is preferably formed thick to eliminate voids during bonding, and the thickness of the adhesive 18 is equal to or greater than the height of the spacer 40. Incidentally, in a case where the thickness of the adhesive 18 is too large, the adhesive 18 is likely to overflow onto the flow path 30 and the piezoelectric element accommodation portion 28 on the one surface 12a. Thus, in the present embodiment, the height of the spacer 40 is 2.0 μm, while the thickness of the adhesive 18 is 2.3 μm.

For the adhesive 18, a material having properties such as high adhesion to substrates, high applicability with few air bubbles, and low viscosity for easy thinning is used. The adhesive 18 does not necessarily have to have all of these properties, but may have one or two of these properties. The properties of the adhesive 18 are not limited to the above-mentioned properties, and the adhesive 18 may have various known properties according to properties required for the bonded substrate 10. Thus, the adhesive 18 is not limited to a benzocyclobutene resin, but may be, for example, an epoxy resin, acrylic resin, silicone resin, polyamide resin, polyimide resin, urethane resin, or the like.

In the present embodiment, the adhesive 18 is applied to the one surface 12a by spin-coating the adhesive 18 on a dry film and transferring the adhesive 18 to the one surface 12a. Incidentally, the method for applying the adhesive 18 to the bonded surface of the substrate is not limited to this. The application method may be, for example, screen printing, or in a case where the adhesive 18 is a photosensitive adhesive, a photolithography patterning technique may be used.

### Step of Forming Functional Film in Second Substrate 14

Next, the second substrate 14 is prepared, and the vibration film 24, lower electrode, piezoelectric element 26, upper electrode, wiring 36, covering layer 38, and the like are formed on the one surface 14a of the second substrate 14 (see FIG. 10C). The vibration film 24 and the insulation film 34 are formed on the one surface 14a to form the lower electrode, piezoelectric element 26, upper electrode, and wiring 36. The method for forming these components is not limited to the above-mentioned method, and various known techniques can be used. For example, the wiring 36 is formed of AiCu by the sputtering method to have a thickness of 0.7 μm. The coating layer 38 is then formed of SiN to have a thickness of 0.2 μm so as to cover the wiring 36. After that, a portion of the covering layer 38 is removed as necessary. In the present embodiment, the covering layer 38 is patterned and removed to form an opening 1004 in a location to communicate with the pressure chamber 20 later and an opening 1006 in a location where the pad 44 and the wiring 36 are connected to each other.

A seed layer 1008 is then formed on the one surface 14a side of the second substrate 14 on which the covering layer 38 is formed (see FIG. 10D). Specifically, on the one surface 14a side on which various functional films including the covering layer 38 are formed, a TiW film having a thickness of 0.2 μm is formed by the sputtering method and a Au film having a thickness of 0.05 μm is formed by the sputtering method to form the seed layer 1008.

Next, the spacer 40 and the pad 44 are formed. Specifically, first, a resist 1102 is applied to the one surface 14a side of the second substrate 14 on which the seed layer 1008 is formed, and patterning is performed so that the resist 1102 remains in areas other than the positions where the pad 44 and the spacer 40 are to be formed through exposure and development (see FIG. 11A). The position where the pad 44 is formed includes the opening 1006. A plating layer 1104 is then formed on the one surface 14a side of the second substrate 14 (see FIG. 11B). In the present embodiment, Au plating is used to form the plating layer 1104, and a known plating solution is used to form the Au plating. The plating layer 1104 may be formed by either electrolytic plating or electroless plating, but in a case where the plating layer 1104 is thick, it is preferable to use electrolytic plating. In electrolytic plating, the second substrate 14 is immersed in a Au plating solution and a current is passed through the surface, thereby growing a plating layer in the portion where the resist 1102 has been removed by patterning. The resist 1102 is then peeled off (see FIG. 11C).

Incidentally, in a case where the spacer 40 and the pad 44 have different thicknesses, the step of patterning with the resist 1102 and growing the Au plating, and the subsequent step of peeling off the resist are performed for each of the spacer 40 and the pad 44. The order of formation is not particularly limited, but in consideration of the applicability and coating performance of the resist 1102, it is preferable to form one with the thinner Au plating first.

After the resist 1102 is peeled off, the seed layer 1008 is then removed (see FIG. 11D). Specifically, after the resist 1102 is peeled off, the seed layer 1008 exposed to the outside is etched. A solution represented by aqua regia capable of selectively etching Au is used to etch Au that forms the seed layer 1008. Further, a hydrogen peroxide solution diluted to a concentration of 30% is used to etch TiW that forms the seed layer 1008.

By removing the seed layer 1008 exposed to the outside by etching, the plating layer 1104 remains in the positions where the spacer 40 and the pad 44 are to be formed. The plating layer 1104 remaining in this manner forms the spacer 40 and the pad 44. Thus, in the present embodiment, the spacer 40 and the pad 44 are formed of the seed layer 1008 and the plating layer 1104. In the present embodiment, the height of the spacer 40 thus formed (the thickness of a combination of the seed layer 1008 and the plating layer 1104) is 2.0 μm.

After the spacer 40 and the pad 44 are formed, the insulation film 34 exposed in the opening 1004 is then removed (see FIG. 11E). Specifically, the insulation film 34 located in the opening 1004 provided in the location where the flow path 30 and the pressure chamber 20 communicate with each other is etched and removed. As a result, the one surface 14a of the second substrate 14 is exposed in the opening 1004. Step of Bonding First Substrate 12 and Second Substrate 14 Together

Next, the first substrate 12 and the second substrate 14 are bonded together (see FIG. 12A). Specifically, the first substrate 12 (see FIG. 10B) worked in the above-mentioned step of forming the first substrate 12 is bonded to the second substrate 14 (see FIG. 11E) worked in the above-mentioned step of forming the second substrate 14. More specifically, the first substrate 12 and the second substrate 14 are aligned (registered) with the one surface 14a side of the second substrate 14 facing the one surface 12a side of the first substrate 12, and the first substrate 12 and the second substrate 14 are adhered to each other under a load. In this case, the first substrate 12 and the second substrate 14 are heated to soften the adhesive 18. In the registered state, the spacer 40 formed on the one surface 14a of the second substrate 14 and the recess 700 formed on the one surface 12a of the first substrate 12 facing the spacer 40 do not overlap in a plane orthogonal to the laminated direction. The adhesive 18 is then cured to bond the first substrate 12 and the second substrate 14 together. The adhesive 18 can be cured by a thermosetting method, an ultraviolet delay-curing method, or the like. In a case where either of the substrates to be bonded together has ultraviolet transparency, an ultraviolet curing method can be used.

During this bonding, the one surface 12a of the first substrate 12 does not contact the covering layer 38 on the wiring 36 due to the spacer 40. Further, the thickness (see H2 in FIG. 6) of the adhesive 18 between the one surface 12a and the covering layer 38 on the wiring 36 is also ensured to be constant by the spacer 40. This makes it possible to suppress damage to the covering layer 38 on the wiring 36. Specifically, since the thickness of the wiring 36 is 0.7 μm, the thickness of the covering layer 38 is 0.2 μm, and the thickness of the spacer 40 is 2.0 μm, the thickness (H2 in FIG. 6) of the adhesive 18 between the one surface 12a and the covering layer 38 on the wiring 36 can be ensured to be at least 1.1 μm. Further, since the thickness of the adhesive is 2.3 μm and the thickness of the spacer 40 is 2.0 μm, the thickness (H1 in FIG. 6) of the adhesive between the one surface 12a and the spacer 40 is 0 μm or more and less than 0.3 μm. That is, the conditions, H2>H1 and H2≥1.0 μm, which are obtained from the results of the above simulation and experiment conducted by the inventor of the present application, for suppressing damage to the covering layer 38 on the wiring 36, are satisfied. Thus, in the present embodiment, the spacer 40 makes the thickness (H2 in FIG. 6) of the adhesive 18 between the one surface 12a and the covering layer 38 on the wiring 36 large enough to suppress damage to the covering layer 38.

### Step of Working Second Substrate 14

After that, the opening 22 and the recess 700 for forming the pressure chamber 20 are formed in the second substrate 14. Specifically, first, the surface of the second substrate 14 that is not bonded to the first substrate 12 is worked, and the second substrate 14 is thinned to form the other surface 14b facing the one surface 14a of the second substrate 14 (see FIG. 12B). It should be noted that since various known techniques can be used to thin the second substrate 14, the description thereof is omitted. Next, the opening 22 is formed in the thinned second substrate 14 (see FIG. 12C). Incidentally, as described above, the spacer 40 is arranged so as not to overlap the opening 22 in which the pressure chamber 20 is formed in a plane orthogonal to the laminated direction. Further, the recess 700 for accommodating the excess adhesive 18 is formed in the thinned second substrate 14 (see FIG. 12C). The recess 700 is also formed so as not to overlap the spacer 40 in a plane orthogonal to the laminated direction. The opening 22 is formed by performing resist patterning on the other surface 14b and then performing silicon etching.

If necessary, a film serving as an etching stop layer may be formed on the lower surface (pressure chamber 20 side) of the vibration film 24. In the present embodiment, the opening 22 and the recess 700 are formed after thinning the second substrate 14 bonded to the first substrate 12, but the present invention is not limited to this. For example, the second substrate 14 in which the opening 22 and the recess 700 are formed in advance may be prepared and bonded to the first substrate 12. Alternatively, the second substrate 14 that has been thinned in advance may be used to form the opening 22 and the recess 700 after being bonded to the first substrate 12.

### Step of Bonding Third Substrate

Next, the third substrate 16 is bonded to the other surface 14b of the second substrate 14. Specifically, first, the adhesive 18 is transferred and applied to the other surface 14b of the second substrate 14 (see FIG. 13A). In this case, the adhesive 18 is not transferred to the opening 22 and the recess 700. To the method for applying the adhesive 18 used in this case, various adhesives and application methods as described above for transferring the adhesive 18 to the one surface 12a of the first substrate 12 can be applied.

Thereafter, the third substrate 16 is prepared, and with the one surface 16a side of the third substrate 16 facing the other surface 14b of the second substrate 14, the second substrate 14 and the third substrate 16 are registered and adhered to each other under a load. In this case, the second substrate 14 and the third substrate 16 are heated to soften the adhesive 18. The adhesive 18 is then cured to bond the third substrate to the second substrate 14. The method for curing the adhesive 18 is appropriately changed depending on the type of adhesive used.

### Step of Working Third Substrate

Next, the ejection port 32 is formed in the third substrate 16. Specifically, first, the surface of the third substrate 16 that is not bonded to the second substrate 14 is worked, and the third substrate 16 is thinned to form the other surface 16b facing the one surface 16a of the third substrate 16. It should be noted that since various known techniques can be used to thin the third substrate 16, the description thereof is omitted. Next, the ejection port 32 is formed in the thinned third substrate 16 (see FIG. 13C). The ejection port 32 is formed by performing resist patterning on the other surface 16b and performing silicon etching.

In the present embodiment, after the third substrate 16 is bonded to the second substrate 14, the ejection port 32 is formed after the third substrate 16 is thinned, but the present invention is not limited to this. For example, the third substrate 16 in which the ejection port 32 is formed in advance may be prepared to bond the third substrate 16 to the second substrate 14. Alternatively, the third substrate 16 that has been thinned in advance may be used to form the ejection port 32 after being bonded to the second substrate 14. After that, in the step of division into chips that can be mounted on a liquid ejection head, a removal portion 1302 (see FIG. 13C) located on the pad storage portion 1002 in the first substrate 12 is removed, so that the bonded substrate 10 can be obtained (see FIG. 13D).

### Example of Applying Bonded Substrate 10

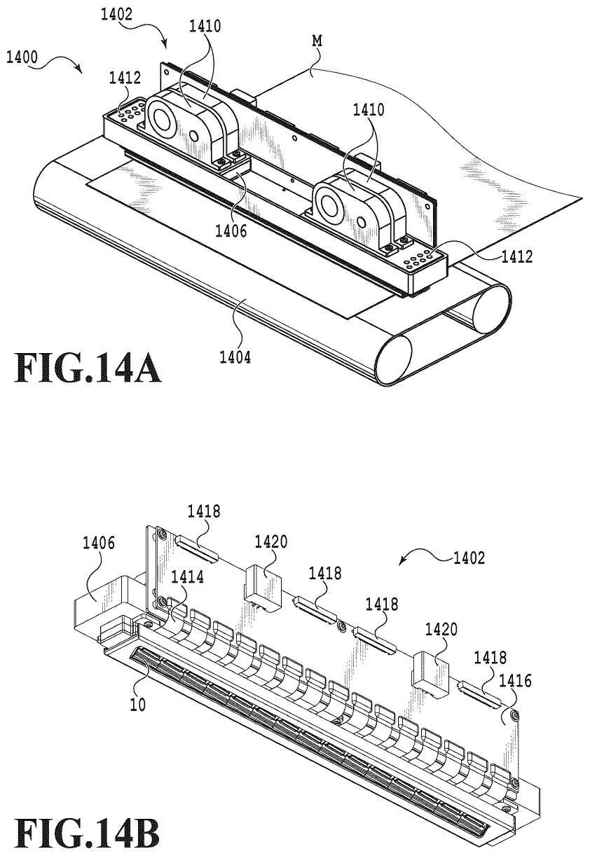

Next, a description will be given of a liquid ejection head including the bonded substrate 10 according to the present embodiment and a liquid ejection apparatus including the liquid ejection head. As an example of the liquid ejection apparatus, a printing apparatus that ejects ink as liquid to perform printing on a conveyed print medium will be described. FIG. 14A is a schematic configuration diagram of the printing apparatus. FIG. 14B is a perspective configuration diagram of a print head as the liquid ejection head including the bonded substrate 10 in the printing apparatus in FIG. 14A.

A printing apparatus 1400 in FIGS. 14A and 14B is a so-called full-line type printing apparatus and includes a long print head 1402 extending across the entire width of a print medium M (see FIG. 14A). The printing apparatus 1400 also includes a conveying portion 1404 that conveys the print medium M in a direction intersecting (in the present embodiment, orthogonal to) the width direction. In the printing apparatus 1400, an image is printed on the print medium M by ejecting ink from the print head 1402 while conveying the print medium M by the conveying portion 1404. In the present embodiment, the print head 1402 is configured to be able to eject four inks, cyan ink, magenta ink, yellow ink, and black ink. As a result, the printing apparatus 1400 is configured to be able to print a color image.

On a surface, facing the conveyed print medium M, of the print head 1402, a plurality of the bonded substrates 10 serving as print element substrates are arrayed in a direction in which the print head 1402 extends (see FIG. 14B). The print head 1402 also includes a liquid supply unit 1406 in which a circulation flow path for supplying ink supplied from an ink tank (not shown) to each bonded substrate 10 and collecting ink that has not been ejected from the ejection port 32 during printing from the bonded substrate 10 is formed. The print head 1402 also includes a negative pressure control unit 1410 for controlling pressure (negative pressure) in the circulation flow path, and a liquid connection portion 1412 serving as a port through which ink is supplied to and discharged from the liquid supply unit 1406 (see FIG. 14A).

Further, the print head 1402 is electrically connected to an electric control portion that supplies power and an ejection control signal to the print head 1402. Specifically, each bonded substrate 10 is connected to the same electric wiring substrate 1416 via a flexible wiring substrate 1414. The electric wiring substrate 1416 is provided with a power supply terminal 1418 for receiving power and a signal input terminal 1420 for receiving an ejection control signal. A print element (piezoelectric element 26) provided in the bonded substrate 10 is driven using power supplied from the power supply terminal 1418 based on the ejection control signal input from the signal input terminal 1420. By driving the print element in this way, ink supplied from the liquid supply unit 1406 and stored in the pressure chamber 20 is ejected from the ejection port 32 in each bonded substrate 10.

### Function and Effect

As described above, the bonded substrate 10, which is a liquid ejection head substrate, is provided with the spacer 40 between the one surface 14a of the second substrate 14 on which the wiring 36 is formed and the one surface 12a of the first substrate 12 bonded to the one surface 14a via the adhesive 18. The spacer 40 is arranged in a position where the spacer 40 does not contact the wiring 36 or the covering layer 38 on the wiring 36. The spacer 40 is also arranged so that in a case of bonding substrates together, the thickness H2 of the adhesive 18 between the covering layer 38 on the wiring 36 and the bonded surface of an opposite substrate is a value that makes it difficult for the covering layer 38 to be damaged by a load during bonding and stress due to warpage of the substrate caused by temperature changes and expansion and contraction of the sealing agent. Specifically, the height of the spacer 40 is set so that the thickness H2 is greater than the thickness H1 of the adhesive 18 between the spacer 40 and the bonded surface of the opposite substrate, and H2≥0.6 μm, more preferably H2≥1.0 μm.

As a result, in the bonded substrate 10, damage to the covering layer 38 on the wiring 36 due to a load generated during bonding between the first substrate 12 and the second substrate 14 is suppressed. Further, in the step of manufacturing the bonded substrate 10 and the step of manufacturing a liquid ejection head using the bonded substrate 10, damage to the covering layer 38 on the wiring 36 due to stress caused by warpage of the substrate due to temperature changes and expansion and contraction of the sealing agent is suppressed.

### Other Embodiments

The above-described embodiment may be modified as shown in (1) to (4) below.
(1) In the above embodiment, the spacer 40 is provided so as not to overlap the wiring 36 and the covering layer 38 on the wiring 36 in a plane orthogonal to the direction in which substrates are laminated, and H2>H1 and H2≥0.6 are satisfied, but the present invention is not limited to this. For example, in a case where stress due to warpage caused by changes in the temperature of a substrate used and expansion and contraction of the sealing agent is small, it is only required that the height of the spacer 40 be greater than the sum of the thicknesses of the wiring 36 and the covering layer 38 on the wiring 36, that is, H2>H1 be satisfied.
(2) In the above embodiment, the piezoelectric element 26 is provided as an energy generation element, but the present invention is not limited to this. Various known energy generation elements, such as an electrothermal conversion element, may be used as the energy generation element. Further, in the above embodiment, the recess 700 is hole-shaped, but the shape of the recess 700 is not limited to this. The recess 700 may have a groove shape extending in a predetermined direction on a surface of the substrate. Furthermore, in the above embodiment, the full-line type print head is used as a liquid ejection head, but the liquid ejection head is not limited to this, and a so-called serial scan type print head may be used.
(3) Although not specifically described in the above embodiment, the spacer 40 has a substantially cubic shape as shown in FIGS. 7A and 7B, but the shape is not limited to this and may be a columnar shape such as a cylindrical shape, an elliptical cylindrical shape, and a polygonal cylindrical shape. Further, the spacer 40 does not necessarily have to have a columnar shape and may have a substantially conical shape whose width gradually increases toward an opposite substrate.
(4) The above embodiment and the various modifications shown in (1) to (3) above may be combined as appropriate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-031791, filed Mar. 4, 2024, which is hereby incorporated by reference wherein in its entirety.

What is claimed is:

1. A liquid ejection head substrate comprising: an energy generation element for imparting energy to liquid, the liquid ejection head substrate comprising:
a first substrate;
a second substrate comprising a bonded surface bonded to a bonded surface of the first substrate via an adhesive and provided with wiring connected to the energy generation element and a covering layer covering the wiring; and
a member provided on the bonded surface of at least one of the first substrate and the second substrate and in a position where the member does not overlap the wiring in a direction in which the first substrate and the second substrate are laminated,
wherein the member has a height so that a second thickness of the adhesive on the covering layer provided on the wiring is greater than a first thickness of the adhesive on the member.

2. The liquid ejection head substrate according to claim 1, wherein
the member has a height large enough to ensure, as the second thickness, a thickness capable of suppressing occurrence of damage to the covering layer on the wiring based on a load during the bonding and stress due to warpage of a substrate caused by a temperature change and due to expansion and contraction of a sealing agent sealing a connection portion connected with an external terminal.

3. The liquid ejection head substrate according to claim 2, wherein
the second thickness is 0.6 μm or more.

4. The liquid ejection head substrate according to claim 3, wherein
the second thickness is 1.0 μm or more.

5. The liquid ejection head substrate according to claim 1, wherein
the first thickness is 0 μm or more and less than 0.3 μm.

6. The liquid ejection head substrate according to claim 1, wherein
a third thickness of the adhesive between the first substrate and the second substrate during the bonding is 3.5 μm or less.

7. The liquid ejection head substrate according to claim 1, wherein
a first recess capable of accommodating the excess adhesive is formed on the bonded surface of the first substrate.

8. The liquid ejection head substrate according to claim 7, wherein
the member is provided on the bonded surface of the second substrate, and
the first recess is formed in a region which the member may contact during the bonding so that an area of the first recess formed in the region is 0% or more and less than 20% of an area of the region.

9. The liquid ejection head substrate according to claim 7, wherein
the member is provided on the bonded surface of the first substrate, and
the first recess is formed in a region where the member is provided on the bonded surface so that an area of the first recess formed in the region is 0% or more and less than 20% of an area of the region.

10. The liquid ejection head substrate according to claim 1, wherein
a liquid chamber storing liquid to which energy is to be imparted by the energy generation element is formed in the second substrate, and
the member is provided in a position where the member does not overlap the liquid chamber in a plane orthogonal to the laminated direction.

11. The liquid ejection head substrate according to claim 10, further comprising
a third substrate bonded to a second bonded surface of the second substrate facing a first bonded surface bonded to the first substrate via the adhesive and comprising an ejection port communicating with the liquid chamber and being capable of ejecting the liquid stored in the liquid chamber, wherein
a second recess capable of accommodating the excess adhesive is formed on the second bonded surface, and
the second recess is formed in a region where the second recess overlaps the member during the bonding in a plane parallel to the second substrate so that an area of the second recess formed in the region is 0% or more and less than 20% of an area of the region.

12. The liquid ejection head substrate according to claim 1, wherein
the member is formed of an inorganic material.

13. The liquid ejection head substrate according to claim 1, wherein
the member is
provided on the bonded surface of the second substrate and
formed of a material identical to a material for at least one functional film formed in the second substrate.

14. The liquid ejection head substrate according to claim 13, wherein
the member is formed of a material identical to a material for a pad for electrical connection.

15. The liquid ejection head substrate according to claim 14, wherein
the member is formed to have a thickness equal to a thickness of the pad.

16. The liquid ejection head substrate according to claim 14, wherein
the member is formed to have a thickness different from a thickness of the pad.

17. The liquid ejection head substrate according to claim 1, wherein
the wiring is formed of metal containing at least aluminum, and
the covering layer is formed of a silicon compound film.

18. The liquid ejection head substrate according to claim 1, wherein
the wiring has a thickness greater than a thickness of the covering layer.

19. The liquid ejection head substrate according to claim 1, wherein
the member is formed of metal made of a seed layer and metal made of a plating layer.

20. A method for manufacturing a liquid ejection head substrate comprising an energy generation element for imparting energy to liquid, the method comprising:
preparing a first substrate;
preparing a second substrate comprising a bonded surface bonded to a bonded surface of the first substrate via an adhesive and provided with wiring connected to the energy generation element and a covering layer covering the wiring; and
bonding the first substrate and the second substrate together via the adhesive,
wherein on the bonded surface of at least one of the first substrate and the second substrate, a member is provided in a position where the member does not overlap the wiring in a direction in which the first substrate and the second substrate are laminated,
wherein in the bonding, the first substrate and the second substrate are bonded together in a state where each of the first substrate and the second substrate is formed on a wafer, and
wherein the member has a height so that a second thickness of the adhesive on the covering layer provided on the wiring is greater than a first thickness of the adhesive on the member.
